(19) United States
(12) Patent Application Publication
(10) Pub. No.: US 2016/0132594 A1
(43) Pub. Date: May 12, 2016

(54) SOCIAL CO-CREATION OF MUSICAL CONTENT

(71) Applicant: Humtap Inc., San Francisco, CA (US)

(72) Inventors: Tamer Rashad, Mountain View, CA (US); Nicole Lusignan, San Francisco, CA (US)

(21) Appl. No.: 14/932,881

(22) Filed: Nov. 4, 2015

Related U.S. Application Data
(63) Continuation of application No. 14/920,846, filed on Oct. 22, 2015.
Application No. 14/920,846 is a continuation of application No. 14/931,740, filed on Nov. 3, 2015.
(60) Provisional application No. 62/067,012, filed on Oct. 22, 2014.
(60) Provisional application No. 62/074,542, filed on Nov. 3, 2014.
(60) Provisional application No. 62/075,141, filed on Nov. 4, 2014.

(51) Int. Cl. G06F 17/30; G06Q 10/10; G06Q 50/00

(52) U.S. Cl. CPC G06F 17/30752; G06Q 50/01; G06Q 10/101; G06F 17/30867; G06F 17/3056; G06F 17/30769

(57) ABSTRACT

Disclosed is a system and method that allows for the online and social creation of music and musical thoughts in real-time or near real-time by amateurs and professionals. Individual musical contributions are combined into a single, cohesive musical thought that is presented for approval to the collaborating creators. This solution is extensible from the world of music to other creative endeavors including the written word, video, and digital images.

### CROSS-REFERENCE TO RELATED APPLICATION

The present application is a continuation and claims the priority benefit of U.S. patent application Ser. No. 14/920,846 filed Oct. 22, 2015, which claims the priority benefit of U.S. provisional application No. 62/067,012 filed Oct. 22, 2014; the present application is a continuation and also claims the priority benefit of U.S. patent application Ser. No. 14/931,740 filed Nov. 3, 2015, which claims the priority benefit of U.S. provisional application No. 62/074,542 filed Nov. 3, 2014; the present application also claims the priority benefit of U.S. provisional application 62/075,141 filed Nov. 4, 2014. The disclosure of each of the foregoing references are incorporated herein by reference

### BACKGROUND OF THE INVENTION

1. Field of the Invention

The present invention generally relates to the creation of content. More specifically, the present invention relates to creation of content in a social environment.

2. Description of the Related Art

The music recording industry generates billions of dollars from multiple strata. These strata include artists, content providers, distributors, consumers, and even intermediate “middleware” providers such as those offering content recommendation. Notwithstanding the immense revenue and the multiple contributors to the generation of that revenue, the social media experience is an unnaturally silent part of the recording industry ecosystem.

For example, there is no social medium for the online creation of music in real time by amateurs or professionals. Messaging has mediums like Twitter and Facebook, still visual images (e.g., digital photography) have Instagram and Flickr, and video content has the likes of Vine and YouTube. But there is no such medium for music.

Nor is there a medium allowing for collaborative digital musical content creation in real-time or near real-time. Content—including but not limited to musical content—is inherently un-social. Content generation typically involves one “write” and many “reads.” For example, a user might post a status update in Facebook. The status has been written and is complete upon posting; there will be no contributions to the update or evolution of the same. While the status update may be read multiple times, there is no collaborative involvement in its generation. Nor is there any collaborative involvement for ‘likes’ or ‘comments,’ as they, too, suffer from the “one right, many read” syndrome. Musical content creation is subjected to the same limitations, if not more so due to the complexity of the musical creative process and the interweaving of musical themes, voices, rhythms, and melodies to create a cohesive musical thought.

There is a need in the art for a system and method that allows for the online and social creation of music and musical thoughts in real-time or near real-time by amateurs and professionals alike. Such a solution would allow for individual musical contributions that are combined into a single, cohesive musical thought that is presented for approval to the collaborating creators. Such a solution would ideally be extensible from the world of music to other creative endeavors including the written word, video, and digital images.

### SUMMARY OF THE PRESENTLY CLAIMED INVENTION

In a first embodiment, a system for social co-creation of musical content is claimed. The system includes a first computing device executing an application front end that receives a first social contribution of a musical thought and a second computing device executing an application front end and that receives a second social contribution of a musical thought. The system includes a web infrastructure that communicatively couples the first and second computing device with a musical information retrieval engine and a composition and production engine. The musical information retrieval engine of the system is executed at a computing device communicatively coupled to the web infrastructure and extracts data from the first and second social contributions of musical thought as provided over the web infrastructure. The composition and production engine is executed at a computing device communicatively coupled to the web infrastructure and processes the data extracted from the first and second social contributions of musical thought in order to generate socially co-created musical content. The socially co-created musical content is then provided over the web infrastructure to the application front end of the first and second computing device for playback.

A second embodiment of the present invention concerns a method for the creation of a collaborative musical thought. Through the method, a first and second social musical contribution are received. Data is extracted from the first and second social contributions of musical thought. An identification of a musical genre is received and a musical blueprint is generated from the extracted data in accordance with the identification of the musical genre. A collaborative musical thought is then generated though application of instrumentation to the musical blueprint, the instrumentation consistent with the musical genre. The collaborative musical thought is then output by way of a front end application that received the first and second social musical contribution.

### BRIEF DESCRIPTION OF THE DRAWINGS

FIG. 1 illustrates a system architecture allowing for the online and social creation of music and musical thoughts in real-time or near real-time.

FIG. 2 illustrates a method for the creation of a first social contribution of a musical thought.

FIG. 3 illustrates a method for the creation of a second social contribution of a musical thought.

FIG. 4 illustrates a method for the creation of a collaborative musical thought based on the first and second social contribution.

FIG. 5 illustrates an exemplary hardware device that may be used in the context of the aforementioned system architecture as shown in FIG. 1 as well as the implementation of various aspects of the methodologies disclosed in FIGS. 2 and 3.

FIG. 6 illustrates an exemplary mobile device that may execute an application to allow for the creation and submission of contributions to a musical thought like those disclosed in FIGS. 2 and 3 and otherwise processed by the system architecture of FIG. 1.

FIG. 7 illustrates a series of application end interfaces as referenced in FIG. 1 and that may provide for the creation and submission of contributions to a musical thought like those disclosed in FIGS. 2 and 3.

### DETAILED DESCRIPTION

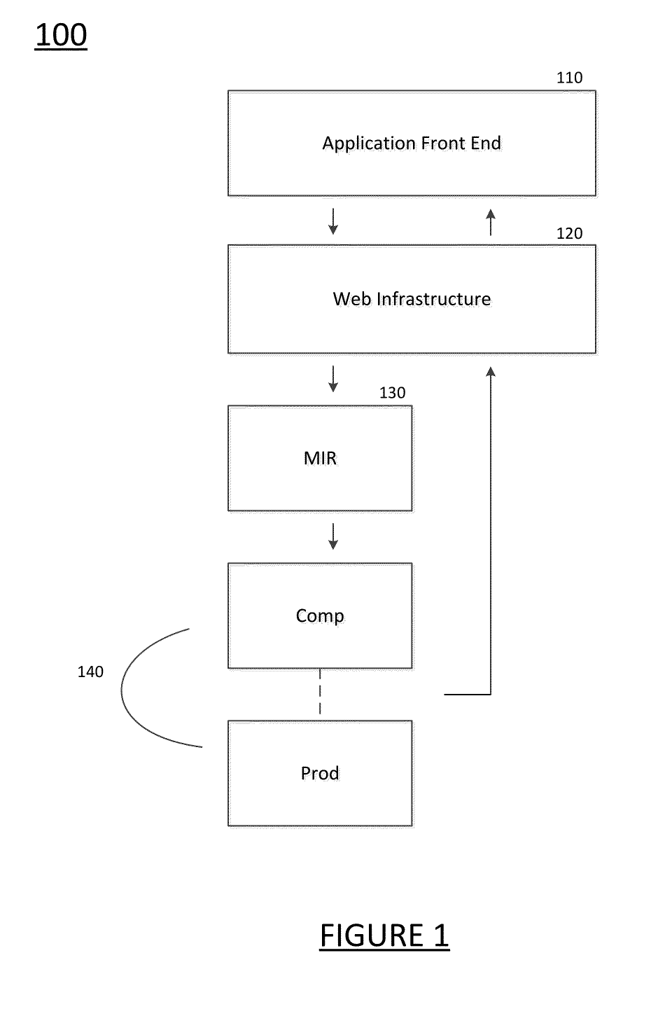

FIG. 1 illustrates a system architecture 100 allowing for the online and social creation of music and musical thoughts in real-time or near real-time. The system architecture 100 of FIG. 1 includes an application front end 110, a web infrastructure 120, a musical information and retrieval engine 130, and a composition and production engine 140. The system architecture 100 of FIG. 1 may be implemented in a public or private network.

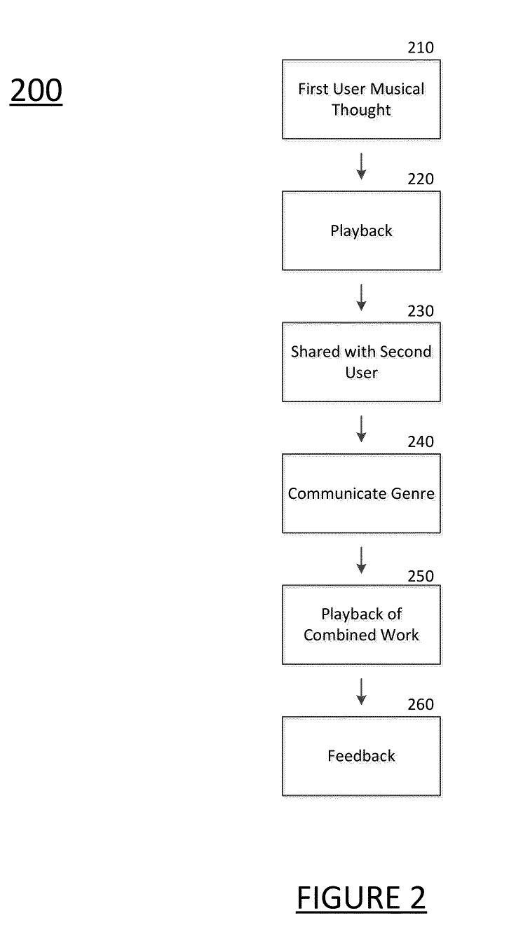

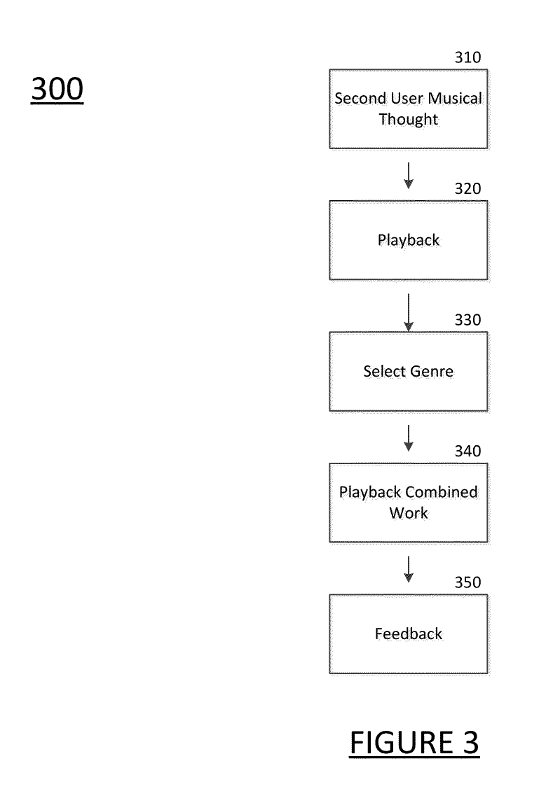

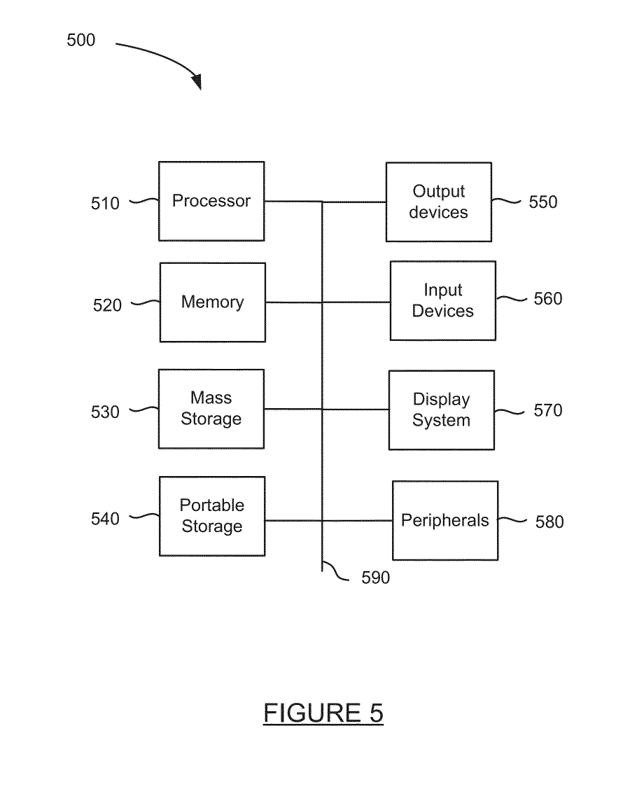

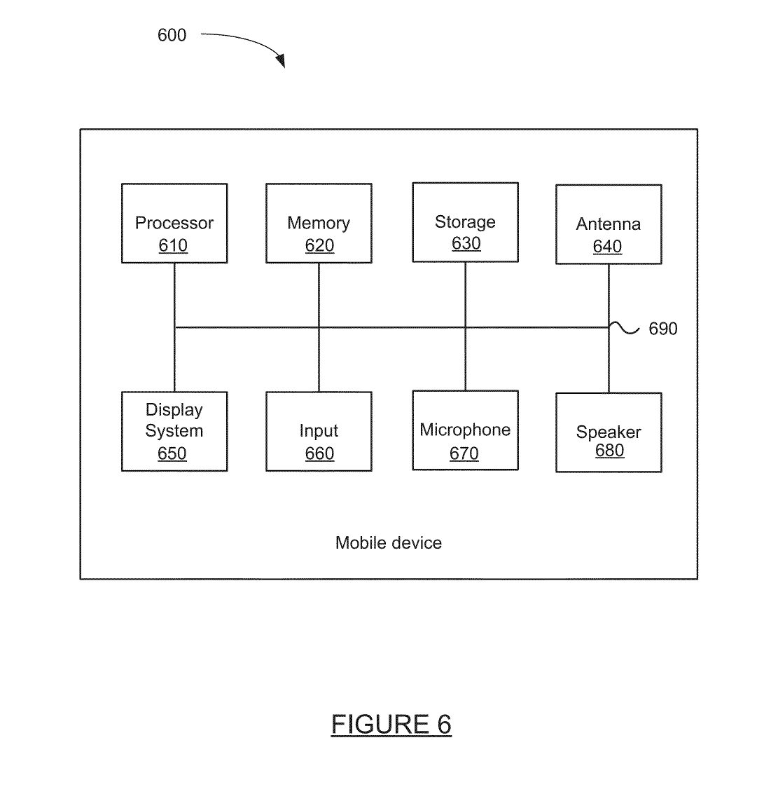

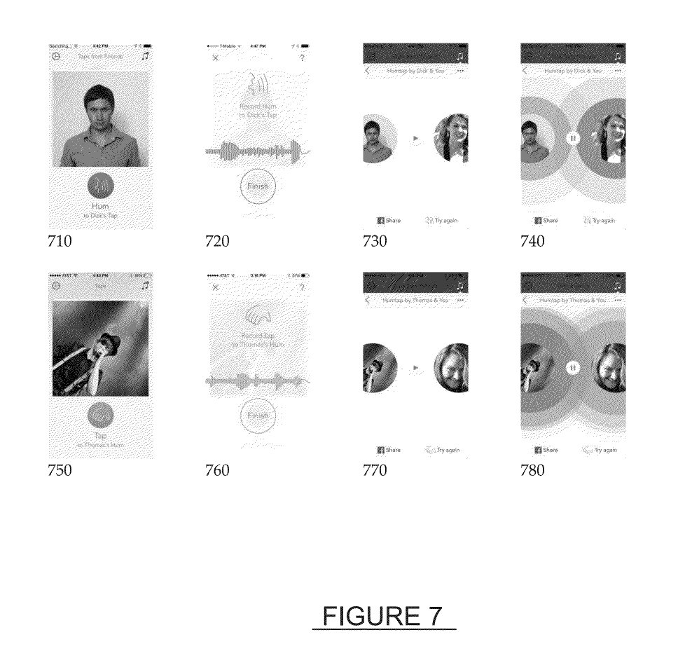

FIG. 1 illustrates application front end 110. Application front end 110 provides an interface to allow users to make social contributions to a musical thought like those discussed in the context of FIGS. 2 and 3. Examples of application front ends 110 are disclosed in the context of FIG. 7 below. A first and second user offer their individual social contributions of musical thoughts (e.g., a “hum” or a “tap” or a “hum” responsive to a “tap” or vice versa). Such social contributions of musical thought may occur on a mobile device 600 like that descripted in FIG. 6 and as might be common amongst amateur or non-professional content creators. Social contributions may also be provided at a professional workstation executing an enterprise version of the present invention as might occur on a hardware device 500 like that described in FIG. 5.

A web infrastructure 120 communicatively couples the first and second computing device with a musical information retrieval engine 130 and a composition and production engine 140. Musical retrieval engine 130 and composition and production engine 150 may each be operating on an individual hardware device 500 like that described in FIG. 5 or may all operate on the same piece of computer hardware. Any number of load balancers may be implemented to ensure proper routing of various social contributions of musical thought to the proper web server executing the proper retrieval engine 130 and/or composition and production engine 140.

Musical retrieval engine 130 executes at a hardware device 500 communicatively coupled to the web infrastructure 120 to extract data from the first and second social contributions of musical thought as provided over the web infrastructure 120. The composition and production engine 140 is likewise executed at a hardware device 150 communicatively coupled to the web infrastructure 120 and processes the data extracted from the first and second social contributions of musical thought in order to generate socially co-created musical content. The socially co-created musical content is provided over the web infrastructure to the application front end 110 of the first and second computing device for playback as is illustrated in the likes of interfaces 730, 740, 770, and 780.

FIG. 2 illustrates a method 200 for the creation of a first social contribution of a musical thought. In step 210 of FIG. 2, a first musical thought is provided by a first user. That contribution may be a “hum” or a “tap.” In step 220, the user is allowed to playback the contribution to ensure that it meets whatever personal musical standards might be possessed by the user. At step 230, that first musical contribution is communicated to a second user for audible observation and feedback.

In an alternative embodiment, the user in FIG. 2 may be provided with a pre-existing piece of content (either a “hum” or a “tap”) in order to provide their music contribution outside of a vacuum. The process would then continue as normal, with the first user contribution being communicated to the second user for an offering of the other “half” of the musical equation. The original ‘inspiration’ in such an embodiment might be disregarded from the process.

In optional step 240, the first user is allowed to communicate a musical genre that will be used in the course of extracting data from the musical contribution and subsequently composing and producing musical output. In step 250, after the second user has contributed their musical thought to the socially co-created work, the user is allowed playback the create work. In step 260, the first user is allowed to offer feedback on the socially co-created work, which may include saving the work, deleting the work, changing the genre, sharing the work, or offering a new contribution of a “hum” or a “tap.”

FIG. 3 illustrates a method for the creation of a second social contribution of a musical thought. In step 310, a second user is prompted to provide a second musical though responsive to the first contribution, for example a “hum.” That is, in the course of FIG. 3, a “hum” is recorded responsive to an originating “tap.” The second user is allowed to listen to the first musical contribution for context and inspiration. In step 320, the second user is allowed to determine whether they are satisfied with their contribution to the overall musical thought. In optional step 330, the second user is allowed to select a musical genre if the first user did not select the same.

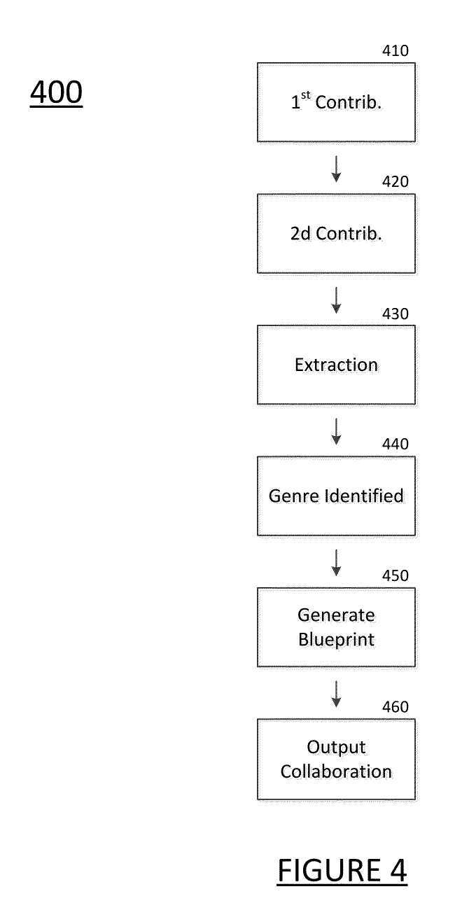

At step 340, and following receipt of the first and second social contributions of musical thought (i.e., the hum and the tap) by the musical information retrieval engine and extraction of certain data for processing by composition and production engine as generally described in FIG. 4, the second user is allowed playback the created work. In step 350, the second user is allowed to offer feedback on the socially co-created work, which may include saving the work, deleting the work, changing the genre, sharing the work, or offering a new contribution of a “hum” or a “tap.”

FIG. 4 illustrates a method 400 for the creation of a collaborative musical thought based on the first and second social contribution. In step 410 of FIG. 4, a first social music contribution is received from a user. The first social musical contribution could be, for example, a “hum” or a “tap.” In step 420, a second music contribution is received. The second contribution is received from a second user and is the responsive pairing to the contribution received in step 410. For example, if a “hum” was received in step 410, then a “tap” is received in step 420. If a “tap” is received in step 410, then a “hum” is received at step 420.

In step 430, various audio features are extracted from the first and second social contributions (i.e., the “hum” and the “tap”). These features, in the case of the “hum” can include essential melodic extracts such as fundamental frequency, pitch, and measure information. In the case of a “tap,” extracted data might include high frequency content, spectral flux, and spectral difference.

In step 440, an identification of genre is received. The genre might be indicative of electronica. The genre might alternatively be indicative reggae. The identified genre of music is used to generate a blueprint from the extracted musical data: the user provided “hum” and “taps.” The genre blue print operates as compositional grammar and rules that applies various grammar and rules to the extracted musical data in a manner similar to the operation of natural language processing. For example, while the contributed musical thoughts from the first and second user will not change, the blue print developed for a reggae genre versus a electronica genre will cause the resulting musical co-creation to differ in presentation.

In step 450, a collaborative musical thought is rendered though application of instrumentation to the musical blueprint. The instrumentation is consistent with the musical genre. Again, the instrumentation that might be present in an electronica type musical production will differ from that in pop, rock, or reggae. The availability of various effects will also differ as will mixing and mastering options.

In step 460, a rendered musical composition of collaborative musical thought is output as individual tracks or an entire composition. That output may be provided through a front end application 110 at a work station like that described in FIG. 5. The output might also be provided on a mobile device like that described in FIG. 6. Various options may follow the rendering of the musical composition such as saving the composition or tracks for future use or playback, sharing the tracks or files, or deleting the rendered product and trying again with a different “hum,” “tap,” or indication of genre.

FIG. 5 illustrates an exemplary hardware device 500 that may be used in the context of the aforementioned system architecture as shown in FIG. 1 as well as the implementation of various aspects of the methodologies disclosed in FIGS. 2 and 3. Hardware device 500 may be implemented as a client, a server, or an intermediate computing device. The hardware device 500 of FIG. 5 is exemplary. Hardware device 500 may be implemented with different combinations of components depending on particular system architecture or implementation needs.

For example, hardware device 500 may be utilized to implement the musical information retrieval 130 and composition and production engines 140 of FIG. 1 while a mobile device like that discussed in the context of FIG. 6 is used for implementation of the application front end 110. Alternatively, a hardware device 500 might be used for engines 130 and 140 as well as the application frond end 110 as might occur in a professional, studio implementation. Still further, engines 130 and 140 may each be implemented on a separate hardware device 500 or could be implemented as a part of a single device 500.

Hardware device 500 as illustrated in FIG. 5 includes one or more processors 510 and non-transitory main memory 520. Memory 520 stores instructions and data for execution by processor 510. Memory 520 can also store executable code when in operation. Device 500 as shown in FIG. 5 also includes mass storage 530 (which is also non-transitory in nature) as well as non-transitory portable storage 540, and input and output devices 550 and 560. Device 500 also includes display 570 and well as peripherals 580.

The aforementioned components of FIG. 5 are illustrated as being connected via a single bus 590. The components of FIG. 5 may, however, be connected through any number of data transport means. For example, processor 510 and memory 520 may be connected via a local microprocessor bus. Mass storage 530, peripherals 580, portable storage 540, and display 570 may, in turn, be connected through one or more input/output (I/O) buses.

Mass storage 530 may be implemented as tape libraries, RAID systems, hard disk drives, solid-state drives, magnetic tape drives, optical disk drives, and magneto-optical disc drives. Mass storage 530 is non-volatile in nature such that it does not lose its contents should power be discontinued. As noted above, mass storage 530 is non-transitory in nature although the data and information maintained in mass storage 530 may be received or transmitted utilizing various transitory methodologies. Information and data maintained in mass storage 530 may be utilized by processor 510 or generated as a result of a processing operation by processor 510. Mass storage 530 may store various software components necessary for implementing one or more embodiments of the present invention by loading various modules, instructions, or other data components into memory 520.

Portable storage 540 is inclusive of any non-volatile storage device that may be introduced to and removed from hardware device 500. Such introduction may occur through one or more communications ports, including but not limited to serial, USB, Fire Wire, Thunderbolt, or Lightning. While portable storage 540 serves a similar purpose as mass storage 530, mass storage device 530 is envisioned as being a permanent or near-permanent component of the device 500 and not intended for regular removal. Like mass storage device 530, portable storage device 540 may allow for the introduction of various modules, instructions, or other data components into memory 520.

Input devices 550 provide one or more portions of a user interface and are inclusive of keyboards, pointing devices such as a mouse, a trackball, stylus, or other directional control mechanism. Various virtual reality or augmented reality devices may likewise serve as input device 550. Input devices may be communicatively coupled to the hardware device 500 utilizing one or more the exemplary communications ports described above in the context of portable storage 540. FIG. 5 also illustrates output devices 560, which are exemplified by speakers, printers, monitors, or other display devices such as projectors or augmented and/or virtual reality systems. Output devices 560 may be communicatively coupled to the hardware device 500 using one or more of the exemplary communications ports described in the context of portable storage 540 as well as input devices 550.

Display system 570 is any output device for presentation of information in visual or occasionally tactile form (e.g., for those with visual impairments). Display devices include but are not limited to plasma display panels (PDPs), liquid crystal displayus (LCDs), and organic light-emitting diode displays (OLEDs). Other displays systems 570 may include surface conduction electron emitters (SEDs), laser TV, carbon nanotubes, quantum dot displays, and interferometric modulator displays (MODs). Display system 570 may likewise encompass virtual or augmented reality devices.

Peripherals 580 are inclusive of the universe of computer support devices that might otherwise add additional functionality to hardware device 500 and not otherwise specifically addressed above. For example, peripheral device 580 may include a modem, wireless router, or otherwise network interface controller. Other types of peripherals 580 might include webcams, image scanners, or microphones although the foregoing might in some instances be considered an input device

FIG. 6 illustrates an exemplary mobile device 600 that may execute an application to allow for the creation and submission of contributions to a musical thought like those disclosed in FIGS. 2 and 3 and otherwise processed by the system architecture of FIG. 1. An example of such an application is front end application 110 as illustrated in the system of FIG. 1. While front end application 110 is presently discussed in the context of mobile device 600, front end application 110 may likewise be executed on a hardware device 500 as might be relevant to professional musicians or audio recording engineers. Mobile device 600 is inclusive of at least handheld devices running mobile operating systems such as the iOS or Android as well as tablet devices running similar operating system software.

Mobile device 600 includes one or more processors 610 and memory 620. Mobile device 600 also includes storage 630, antenna 640, display 650, input 660, microphone or audio input 670, and speaker/audio output 680. Like hardware device 500, the components of mobile device 600 are illustrated as being connected via a single bus but may similarly be connected through one or more data transport means as would be known to one of ordinary skill in the art.

Processor 610 and memory 620 function in a manner similar to that described in the context of FIG. 5: memory 620 stores programs, instructions, and data in a non-transitory, volatile format for execution by processor 610. Storage 630 is meant to operate in a non-volatile fashion such that data is maintained notwithstanding an accidental or intentional loss of power. For example, storage 630 might maintain one or more applications or ‘apps’ including an ‘app’ that would implement the functionality of front end application 110.

Differing from hardware device 500 is the presence of antenna(s) 640 in mobile device 600. Antenna(s) 640 allow for the receipt and transmission of transitory data by way of electromagnetic signals that may comply to one or more data transmission protocols including but not limited to 4G, LTE, IEEE 802.11n, or IEEE 802.11AC as well as Bluetooth. While data may be transmitted to and received by antennas 640 in a transitory format, the data is ultimately maintained in non-transitory storage 630 or memory 620 for use by processor 610. Antenna may be coupled to a modulation/demodulation device (not shown) allowing for processing of wireless signals. In some instances, wireless processor functionality may be directly integrated with processor 610 or be a secondary or ancillary processor from amongst the group of one or more processors 610.

Display 650 of mobile device 600 provides similar functionality as display system 570 in FIG. 5 but in a smaller form factor. Display 650 in mobile device 600 may also allow for delivery of touch commands and interactions such that display 650 also integrates some input features not otherwise capable of being managed by input 660. Such a display may utilize a capacitive material arranged according to a coordinate system such that the circuitry of the mobile device 600 and display 650 can sense changes at each point along the grid thereby allowing for detection and determination of simultaneous touches in multiple locations.

Input 660 allows for the entry of data and information into mobile device 600 by a user of the mobile device 600. Components for input might include physical “hard” keys or even an integrated physical keyboard, including but not limited to a dedicated home key or series of selection and entry buttons. Input 660 may also include touchscreen “soft” keys as discussed in the context of display 650.

Voice instructions might also be provided by way of built-in microphone or audio input 670 operating in conjunction with voice recognition and/or natural language processing software. Microphone/audio input 670 is inclusive of one or more microphone device that transmit captured acoustic signals to processing software executable from memory 620 by processor 610. Microphone/audio input 670 various forms of social contributions of musical thought.

Output may be provided visually through display 650 as textual or graphic information. The information may be presented in the form of a query. Output may audibly be provided through speaker component 680. Output may request confirmation of an instruction, seek acceptance of a sample, or may simply allow for playback of socially co-created musical content. The specific nature of any output and the particular means in which it is presented—audio or video—may depend upon the software being executed and the end result generated through execution of the same.

FIG. 7 illustrates a series of application end interfaces 700 as referenced in FIG. 1 (110) and that may provide for the creation and submission of contributions to a musical thought like those disclosed in FIGS. 2 and 3. Through the series of application end interfaces 700 as shown in FIG. 7, a first user provides one musical thought that is presented to a second user for a further contribution of musical thought. The combined musical thought, which reflects both that of the first and second user, is then presented for approval by one or both users.

In interface 710 of FIG. 7, a first musical thought—a “tap”—has been received from a first user (Dick). The user of mobile device 600 has been prompted by interface 710 to provide a second musical though responsive to the first contribution, specifically a “hum.” In interface 720, a “hum” is recorded responsive to Dick's “tap.”

Instructions related to the rendering of the application may be retrieved from storage 630 of mobile device 600 and then executed from memory 620 by processor 610. The resulting interface 710 and 720 is displayed on display 650. Playback of Dick's “tap” may occur through engaging display 650 and/or input 660, which allows for the playback of the “tap” through speakers 680. A “hum” from the user of mobile device 600 may be recorded by microphone 670 operating in conjunction with display 650.

Following receipt of the first and second social contributions of musical thought (i.e., the hum and the tap), the musical information retrieval engine is executed at a computing device. A composition and production engine executed at a computing device processes the data extracted from the first and second social contributions of musical thought in order to generate socially co-created musical content that corresponds to a particular genre. The socially co-created musical content is provided over the web infrastructure to the application front end 730 and is played back in interface 740. Following playback of the socially co-created musical content, any number of decisions may be made including whether to save the socially co-created musical content, to share the content, or to re-attempt the social co-creation.

A similar process is displayed in the context of interfaces 750-780. Interfaces 750-780, however, reflect the first musical thought contribution being a “hum” versus a “tap” (750). The user of mobile device 600 provides their “tap” by way of interface 760 operating in conjunction with display 650 as well as microphone 670 and as was generally described in the immediately prior reverse operation flow. Following processing of the first and second musical thoughts (i.e., the “hum” and the “tap”), the musical information retrieval engine is executed at a computing device. A composition and production engine executed at a computing device processes the data extracted from the first and second social contributions of musical thought in order to generate socially co-created musical content that corresponds to a particular genre. The combined creation is provided for playback in interface 770 and actually played back in interface 780. Like the “tap-to-hum” process above, the combined social contributions may be saved, shared, or attempted again.

Other embodiments of the invention might include content creators making music together in any form, such as a virtual DJ or concatenating musical thoughts. More generalized musical ideas, too, may be correlated to more specific musical contexts to assist in content creation. The iterative process may, in some embodiments, go beyond a first and second contribution and involve multiple contributions from multiple users, the user of social influencers and weighting as may be driven by a user profile, and contributing to an already combined work product (e.g., adding a further drum beat through a series of taps to an already exist tap track).

The present invention is not meant to be limited to musical content. The concepts disclosed herein may be applied to other creative contexts, including video, the spoken word, or even still images/digital photography. The fundamental underlying concepts of contribution of individual thoughts that are melded together in light of various considerations of genre nevertheless remains applicable.

The foregoing detailed description has been presented for purposes of illustration and description. The foregoing description is not intended to be exhaustive or to the present invention to the precise form disclosed. Many modifications and variations of the present invention are possible in light of the above description. The embodiments described were chosen in order to best explain the principles of the invention and its practical application to allow others of ordinary skill in the art to best make and use the same. The specific scope of the invention shall be limited by the claims appended hereto.

What is claimed is:

1. A system for social co-creation of musical content, the system comprising:
a first computing device executing an application front end and that receives a first social contribution of a musical thought;
a second computing device executing an application front end and that receives a second social contribution of a musical thought;
a web infrastructure that communicatively couples the first and second computing device with a musical information retrieval engine and a composition and production engine;
a musical information retrieval engine executed at a computing device communicatively coupled to the web infrastructure and that extracts data from the first and second social contributions of musical thought as provided over the web infrastructure; and
a composition and production engine executed at a computing device communicatively coupled to the web infrastructure and that processes the data extracted from the first and second social contributions of musical thought in order to generate socially co-created musical content, wherein the socially co-created musical content is provided over the web infrastructure to the application front end of the first and second computing device for playback.

2. A method for the creation of a collaborative musical thought, the method comprising:
receiving a first social musical contribution;
receiving a second social musical contribution;
extracting data from the first and second social contributions of musical thought;
receiving an identification of a musical genre;
generate a musical blueprint from the extracted data in accordance with the identification of the musical genre;
render a collaborative musical thought though application of instrumentation to the musical blueprint, the instrumentation consistent with the musical genre; and
output the collaborative musical thought by way of a front end application that received the first and second social musical contribution.
